(19) United States
(12) Patent Application Publication
(10) Pub. No.: US 2005/0055568 A1
(43) Pub. Date: Mar. 10, 2005

(54) Method and system for providing physical security in an area of interest

(76) Inventors: Ashok K. Agrawala, Ashton, MD (US); Moustafa Amin Youssef, Hyattsville, MD (US); Layla Shahamat, Rockville, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/916,545

(22) Filed: Aug. 12, 2004

Related U.S. Application Data
(60) Provisional application No. 60/494,542, filed on Aug. 12, 2003.

(51) Int. Cl. G06F 11/30

(52) U.S. Cl. 713/200

(57) ABSTRACT

A system for detecting the presence of an intruder in a protected area utilizes a received signal strength indicator (RSSI) value of signals broadcast from transmitting stations deployed in the protected area. The system includes monitoring points for receiving broadcast signals, measuring the RSSI values of the received signals, and transmitting the measured RSSI values to a security system server. The security system server analyzes the RSSI values, and initiates security measures when the physical security of the protected area is violated which is detected when the measured RSSI values deviate from a predetermined strength of the broadcast signals. The security system also has the ability to track objects in the protected area and keep track of their movement in real time and report such movement. The system may be based on a Wi-Fi infrastructure in the protected area.

This Utility patent application is based on Provisional Patent Application No. 60/494,542, filed Aug. 12, 2003.

### FIELD OF THE INVENTION

The present invention relates to security systems, and in particular to detection of the presence of objects in an area of interest.

In essence, the present invention relates to a security system which exploits wireless fidelity (Wi-Fi) infrastructure in an area of interest in order to detect the presence of objects in the area of interest.

Further, the present invention relates to a security system based on the Wi-Fi implementation of the communication capabilities in offices, residences, public places, and/or the outdoors, which detects the presence of objects, and upon detecting the violation of the physical security of the area of interest, generates appropriate messages which can be sent using the Internet, and/or can be used for notification of security people/agencies. Initiation of security action is also contemplated in the security system.

The present invention also is directed to a security system which has the ability to track the presence and movement of objects in the area of interest in real time and to report the movement of the detected objects.

The present invention further relates to a security system having a plurality of monitoring points interconnected with a plurality of transmitters (or an access point network of the Wi-Fi infrastructure) deployed in the area of interest and transmitting signals of a predetermined strength level. The monitoring points measure the received signal strength indicator (RSSI) values of the signals transmitted by the transmitters and supply the RSSI values to a security system server. The security system server analyzes the RSSI values received from the monitoring points of the security system, determines whether the RSSI values of the signals received at the monitoring points deviate from the predetermined RSSI value (strength level) corresponding to the state of the security system when no presence of an unwanted object is detected in the area of interest and issues a warning indicia (notification, messages through the Internet, security actions, etc.) once the violation of the security in the area of interest has been detected.

### BACKGROUND OF THE INVENTION

In recent years, wireless fidelity (Wi-Fi) installations have been increasing at a very rapid pace, to provide communication capabilities in offices, residences, and public places. In an office environment, Wi-Fi usually employs an infrastructure mode in which a number of access points (APs) are placed at carefully selected locations and are assigned channels so that one can have access from any location in the office with minimal interference from neighboring APs as well as their traffic. Usually, the Access Points are installed to communicate with workstations, laptops, and other devices containing wireless cards. The Access Points may also be connected to the wired network of the enterprise, and are used to provide Internet access and other communication capabilities. One of the most common AP types is the 802.11 or “wireless Ethernet” access point connecting an Ethernet network to Wi-Fi devices, but other devices (such as those connecting mobile phones to wired phone networks) can also be considered access points.

Although having several drawbacks, such as being behind wired networking in terms of bandwidth and throughput, as well as the need for means to discern if a particular user was authorized to access a network or not (security issues), the Wi-Fi implementation has become extremely popular for providing communication within and between networks. It is therefore desirable to further explore the capabilities of Wi-Fi technology and, in particular, to improve security in an area of interest using the Wi-Fi technology.

### SUMMARY OF THE INVENTION

It is therefore an object of the present invention to provide a system and method for assuring physical security in an area of interest which detects a violation of the physical security in such an area based on a Received Signal Strength Indicator (RSSI) value of the signals crossing the area of interest, and generates appropriate messages (which can be sent using the Internet), as well as initiating security actions when the security violation is detected.

It is another object of the present invention to provide a Wi-Fi based system for security purposes in an area of interest which is capable of detecting the presence of objects at times when no object is supposed to be detected.

It is a further object of the present invention to provide a physical security system using Wi-Fi infrastructure deployed in the area of interest, which, upon detecting the violation of the physical security in the area of interest, will have the ability to track objects and keep track of their movement in real time and report such movement to security people/agencies.

In one aspect, the present invention is a security system for wireless fidelity (Wi-Fi) infrastructure deployed in an area of interest and including an access point network interconnecting a wireless network and a wired network (or wireless networks, or wired networks). The security system of the present invention comprises a plurality of monitoring points interconnected with the access point network. Each monitoring point receives a signal (which may be a beacon) broadcast by the access points at predetermined time intervals, and measures a received signal strength indicator (RSSI) value of the received signal. The signals transmitted by the APs have a predetermined strength level.

The security system further includes a security system server which communicates with the monitoring points and receives the RSSI values from them for analysis. If a deviation of the RSSI value from the predetermined strength level has been detected, the security system server issues a warning indicia, such as, for example, messages sent over the Internet, notifications to be transmitted to security agencies, or initiation of other security measures.

The security system server stores a topology of the Access Points in the area of interest, as well as the topology of the Monitoring Points. These topologies are used by the security system server for analyzing the part of the area of interest in which movement of unauthorized objects has been detected, and for tracking in real time the intruding objects.

The APs, as well as MPs, are transceivers. For the purpose of the present invention, the APs are senders of signals while the MPs are receivers of beacons broadcast from the APs. The hardware of the security system measures the RSSI values of each signal received from the APs, specifically at MPs, and represents the RSSI value in the physical layer header for transmission to the security system server. Each monitoring point has means for keeping track of the RSSI values of the signals transmitted from the respective access point.

In the least expensive implementation, which is not necessarily based on Wi-Fi installation, the system of the present invention includes a plurality of transmitters, a plurality of Monitoring Points, and a server. In this arrangement, the transmitters are deployed in the area of interest, and broadcast signals of a fixed strength level at predetermined time intervals. The broadcast signals, along with the ID of the sending transmitter, are received at the Monitoring Points and the RSSI value of each signal arriving at the MP is measured. The MP keeps track of the RSSI values, and sends the RSSI values along with the MP's ID and time stamp to the security system server for further analysis. If the server detects that the received RSSI value deviates from the fixed strength of the signal broadcast from the AP, that is indicative of the presence of an object in the area of interest, the server subsequently initiates security measures.

In another aspect of the present invention, a method for monitoring physical security in an area of interest using wireless fidelity (Wi-Fi) infrastructure having an access point network interconnecting wireless and/or wired networks is provided. The method includes the following steps:
deployment of a plurality of monitoring points in the area of interest;
broadcasting signals of a predetermined strength level by the APs;
receiving the signals at Monitoring Points and measuring their RSSI values; and
issuing a warning indicia when the measured RSSI value deviates from a predetermined strength level.

In an alternative form of the method of the present invention, a plurality of stand-alone transmitters (which are not necessarily associated with wired and/or wireless network) are spread over the area of interest. The transmitters send signals of a predetermined strength level at predetermined time intervals. These signals are received at MPs, and the RSSI values of each signal are measured.

The method further includes transmitting the RSSI values from the monitoring points to the security server along with the ID of the monitoring point, as well as the time stamp of the transmission, and analyzing the RSSI values in the security server.

For operating the security system, the topology of the access points (or transmitters), as well as the topology of the monitoring points, are recorded in the security server to allow the security server to define the exact part of the area of interest where the violation of security has been detected, and for further tracking the movement of the unauthorized object within the area of interest.

The method of the present invention allows the security system of the present invention to run in monitoring, tracking, and security modes of operation.

The monitoring mode of operation is initiated for detecting the presence of an intruder when no movement of the object in the area of interest is expected. In the monitoring mode of operation, in addition to measurements and transmissions of the RSSI values to the server, the method may allow the monitoring point(s) to recognize the deviation of the RSSI value from the predetermined strength level, and to transmit a notification signal indicative of the deviation detection from the monitoring point(s) to the security server.

During the tracking mode of operation, the presence of an intruder can be detected, along with the location of the intruder, and a path taken by the intruder in the area of interest. In the tracking mode of operation, the method of the present invention allows recordation of the measured RSSI values at each monitoring point, and transmission of the measured RSSI values from the monitoring points to the security system server; and at the security system server, identifying the location of the APs which transmit the signals indicative of the presence of the intruder, along with computing the location of the intruder based on the topology of the APs and MPs.

In the security (or multple-tracking) mode of operation, the method of the present invention allows tracking of multiple objects in the area of interest and keeps track of the movement of each object in the area.

The method of the present invention further includes measuring, preferably at MPs, the RSSI values of the signals broadcast from the APs and transmitting the measured RSSI values represented in the header of a physical layer frame to the security system server.

These features and advantages of the present invention will be fully understood and appreciated from the following detailed description of the invention in conjunction with the accompanying Drawings.

### BRIEF DESCRIPTION OF THE DRAWINGS

FIG. 1 is a simplified schematic representation of the security system of the present invention based on Wi-Fi infrastructure;

FIG. 2 is a schematic representation of the system of the present invention taken on a more detailed scale;

FIG. 3 is a schematic representation of an alternative embodiment of the security system of the present invention;

FIG. 4 is a schematic representation of the system of the present invention showing interconnection between elements of the system;

FIG. 5 is a schematic representation of the system of the present invention using APs both for transmitting the beacons to the MPs and for passing the RSSI values from the MPs to the security system server;

FIG. 6 is a schematic representation of the MP transceiver (in the receiver mode);

FIG. 7 is a simplified schematic representation of the AP transceiver (in the transmitter mode); and

FIG. 8 is a diagram of RSSI values vs. time illustrating the capability of the system of the present invention to detect the presence of objects in the area of interest.

### DETAILED DESCRIPTION OF THE PREFERRED EMBODIMENTS

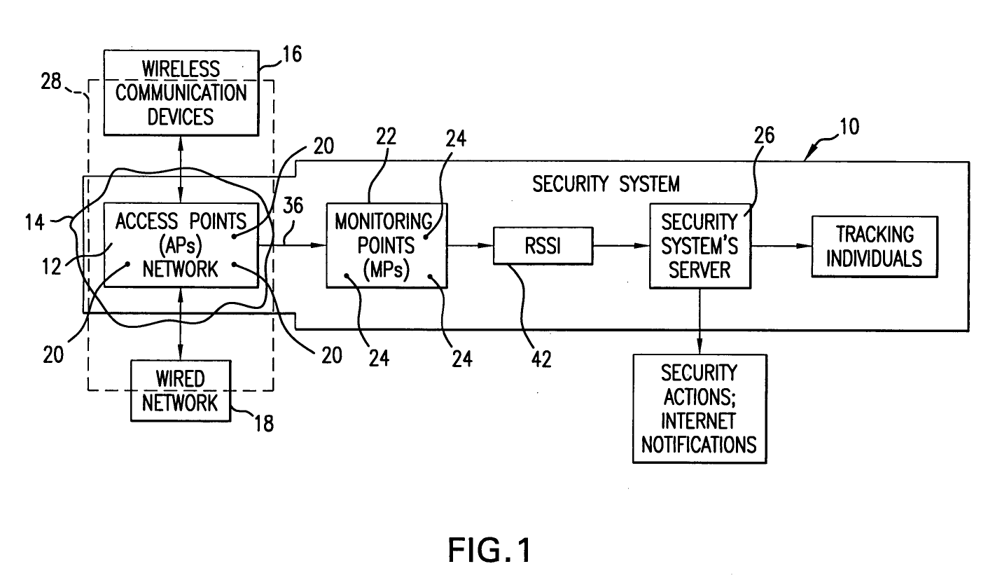

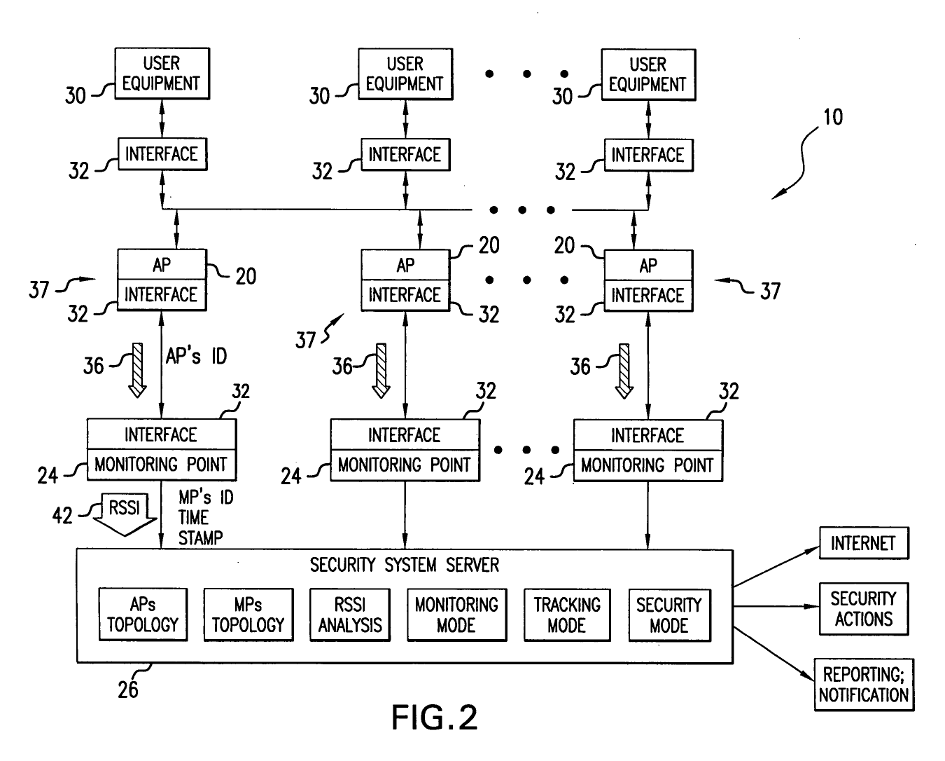

Referring now to FIGS. 1-5, a security system 10 of the present invention (referred to also as “Nuzzer technology”) includes a plurality of transmitting stations, which, in a Wi-Fi based embodiment of system 10, may be represented by an access point network 12, referred to herein as an AP network, deployed in an area of interest 14. The area of interest may include any area to be protected, both indoors and outdoors; for example, offices, commercial centers, pipelines, highways, airports, military sites, etc. For the sake of simplicity, but not to in any way restrict the area of application of the teachings of the present invention, the area of interest will be described herein as an office environment, although other environments may also be protected by the security system of the present invention. The AP network 12 connects wireless communication devices together to create a wireless network 16. The AP network 12 is also connected to a wired network 18 and, thus, can relay data between devices both in and between the wired network 18 and wireless network 16. Access points 20 in the AP network 12 may be the 802.11 or “wireless Ethernet” access points connecting an Ethernet network to Wi-Fi devices, as well as to other devices, such as, for example, those connecting mobile phones to wired phone networks.

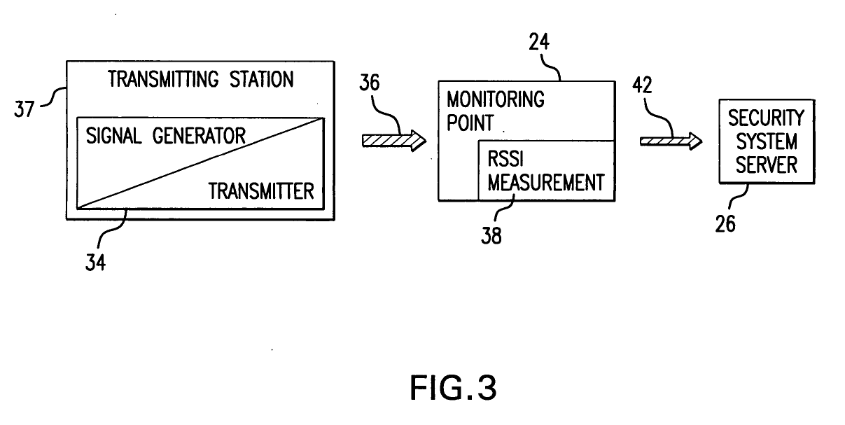

The system 10 also may be implemented without the use of Wi-Fi technology. Then, the access points may be stand-alone transmitters, not associated with wired or wireless networks. This embodiment is shown in FIG. 3, and will be described in further detail below.

The transmitting stations (access points 20, also referred to herein as APs), are placed at carefully selected locations of the protected area 14 and are assigned communication channels (operating radio frequency), so that a user can have access from any location in the area of interest; e.g., an office, with minimal interference from other APs as well as their traffic.

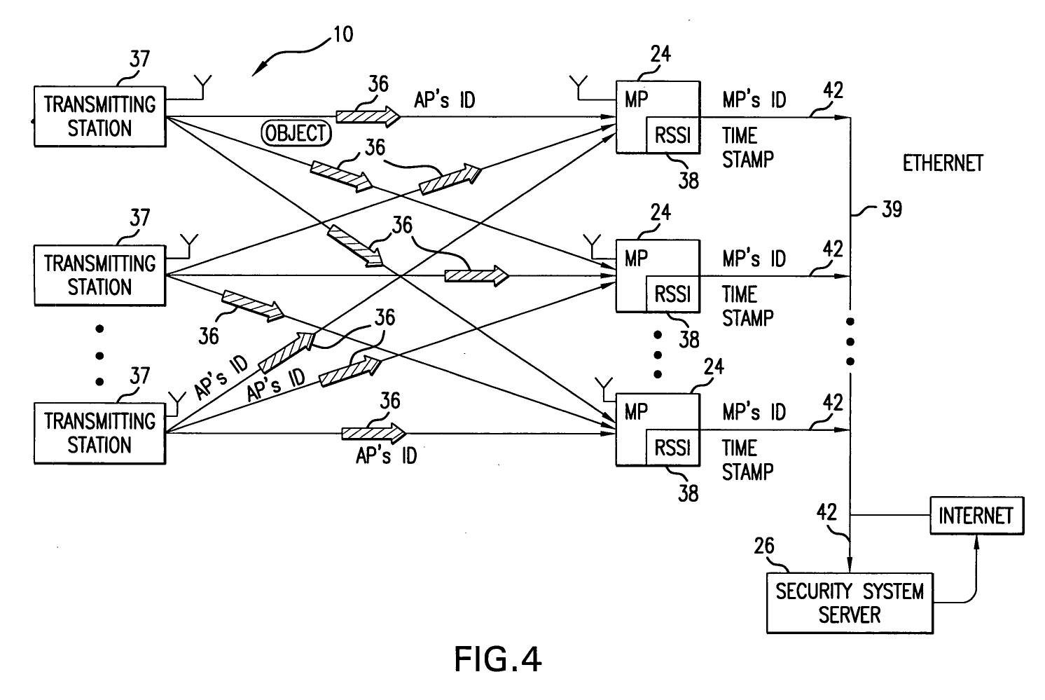

The security system 10 further includes an array 22 of monitoring points 24 coupled to the AP network 12 for receiving therefrom signals, to be discussed in further detail. In the system 10, as best shown in FIG. 4, each monitoring point 24 communicates with all transmitting stations (or APs). Further, the security system 10 of the present invention includes a security system server 26 coupled to the monitoring points 24 for receiving data therefrom, analyzing such data, and for detecting whether any security violation in the area of interest 14 has been made. If a detection occurs, the security system server takes the security actions it is preprogrammed for.

The security system 10 can detect the presence of an object in the area of interest 14 at times when no object is supposed to be in the area 14. The objects may include people, vehicles, airplanes, trains, etc. in the protected area. For the sake of simplicity, and not to limit the scope of the present invention, the further description will refer to the objects as people. On detecting the violation of the physical security in the area 14, the security system 10, by means of the security system server 26, generates appropriate messages which can be sent using the Internet, can be used for notification and can be used for initiating other security actions. The security system 10 of the present invention also has the ability to track the individuals in the area 14, to keep track of their movement in real time, and to report such movement.

The security system 10 of the present invention, as shown in FIGS. 1-2 and 4-5, may use the standard components of any Wi-Fi installation 28 which provides wireless access, by installing the access points 20, to workstations, laptops, personal digital assistants, and other user equipment 30. The user equipment 30, APs 20, and MPs 24, may contain interface devices 32, also referred to herein as transceivers or wireless cards. The APs 20 may be connected to the wired network 18 of the enterprise to provide Internet access and other capabilities.

The security system 10 of the present invention may use the installed Wi-Fi infrastructure of the enterprise (for instance, an office, public place, or other commercial enterprise), e.g., the AP network 12, as the hardware base in a distributed software system. The security system 10 provides physical security capability to the standard Wi-Fi installation by adding the monitoring points 24 and the security system server 26 for purposes to be discussed in detail further below.

The operation of the security system 10 of the present invention is based on the received signal strength indicator (RSSI) values of signals which are broadcast by APs 20 (transmitting stations). For Wi-Fi implementation of the system 10, the interface devices (transceivers) of the APs may be 802.11 cards. It will be understood by those skilled in the art that, although, the term “card” is used, the interface device may be implemented as an embedded unit or as an on-chip structure. Some of the cards 32 may include flash memory along with connectivity, which insures good connectivity with the access points 20. The cards 32 of the wireless devices 30 may include an external antenna connector to allow the placement of the antenna on top of a desk. The wireless cards are well-known to those skilled in the art, and are not going to be discussed here in detail. It is, however, important to mention that these cards are interface means between the devices 30 and the access points 20, as well as between the APs 20 and the MPs 24, of the system 10 which may provide extended memory, modems, connectivity to external devices, and wireless LAN capabilities to laptops, and other computing devices.

In the systems 10, communication between interface devices 32 of the user equipment 30, interface devices 32 of the access points 20, as well as interface devices 32 of the monitoring points 24 is managed and maintained by coordinating access to a shared radio channel and utilizing protocols that enhance communication over a wireless medium. Usually, in order to transform a raw transmission facility into a line that appears free of transmission errors in the network layer, a sending station breaks the input data up into data frames, transmits the frames sequentially, and process the acknowledgement frames sent back by the receiver.

Periodically, access points 20 broadcast a beacon, and the radio card 32 of the device 30 receives these beacons while scanning and takes note of the corresponding signal strength, represented as the received signal strength indicator (RSSI) value reported in the physical layer header. The beacon contains information about the access point 20 it is sent from, including the service set identifier (SSID), supported data rates, etc. The radio card 32 of the device 30 can use this information along with the signal strength to compare access points and decide upon which one to use.

In the security system 10 of the present invention, the access points 20 broadcast signals 36 (which, as an example, may be beacons). These signals transmitted from the APs may be sent at a predetermined interval (for example, 100 ms), or at unequal time intervals. When the signal 36, along with the ID of the access point 20, is received by a receiver of a monitoring point 24, it not only extracts and supplies data to the higher layers, but also measures the RSSI values which are further reported in the physical layer header to the security system server 26.

The security system 10 of the present invention uses these RSSI values of the signals transmitted from the access points 20 to detect whether the violation of the physical security in the area of interest has occurred.

The RSSI value is usually a reflection of the received signal power, specifically the wideband received power within the relevant channel bandwidth in a specified time slot. Measurement of the RSSI may be performed on an UTRAN DL carrier (UTRAN is well-known to those skilled in the art as a communication architecture which consists of a set of radio network subsystems connected to the CN (core network) through a logical interface). The reference point for the RSSI is an antenna connector at user equipment 30.

In the security system 10 of the present invention, monitoring points 24 receive the signals 36 broadcast from the access points 20 and measure the RSSI values of the signals arrived at the monitoring points 24. The monitoring point 24 keeps track of the RSSI values of the signals 36 received from the access points 20 along with IDs of the broadcasting access points, and transmits the RSSI values to the server 26. The server 26 compares the received RSSI values with a predetermined RSSI value of the signal for a “no intruder in the area of interest” condition. The server 26 has the topology of the protected area 14, including the positioning of the access points 20, as well as the topology of the monitoring points 24, so that once the RSSI values deviate from the predetermined “no intruder” RSSI value, the security system server 26 determines that violation of the physical security in the area 14 has occurred, and uses the topology of the disposition of access points 20 (as well as information on the respective monitoring points 24), to determine the location of an intruder. Upon detecting the physical violation in the area 14, the security system server 26 raises an alarm as required. The issuance of the alarm indicia may have many forms, including sending messages through the Internet, notifying security individuals/organizations, and/or initiating other security actions.

Referring now to FIG. 3, an alternative, the least expensive embodiment of the system of the present invention, is not associated with Wi-Fi installation and does not use 802.11 Access Points. Instead, the security system 10, shown in FIG. 3 includes a plurality of transmitting stations 37, which periodically transmit signals 36 of a predetermined strength. Each of the transmitting stations 37 includes a signal generator/signal transmitter 34 for generating (periodically or not) and sending signals 36 of the same strength. The transmitters 34 are deployed in the protected area 14. These are stand-alone transmitters which are not necessarily associated with wired or wireless networks. The signal 36, along with the ID of the transmitter 34, is received at the receiver of the monitoring point 24, and the RSSI value of the received signal is measured by the hardware 38, as will be further presented. The RSSI value of the signal 36 arrived at the monitoring point 24 is representative of the presence or absence of an object in the protected area between the transmitter 34 and the monitoring point 24. If the RSSI value of the signal received at the MP 24 is the same as the predetermined strength value of the signal 36 sent from the transmitter 34, then there is no intrusion in the area of interest. If however, the RSSI value of the signal received at the MP 24 is lower, than the “no intrusion” RSSI value, that may be indicative of a possible presence of an object in the protected area, then the security system server 26 analyzes data, and initiates security actions if the intrusion is detected.

Referring now to FIG. 4, the security system 10 of the present invention is shown which, in this embodiment, may be or may be not based on standard Wi-Fi installation. The system 10 includes a plurality of transmitting stations 37. Each transmitting station either includes an RF signal generator/transmitter 34 or an access point 20 (for Wi-Fi implementation). In the embodiment shown in FIG. 4, APs 20 are used for transmitting signals 36. As shown, the transmitting stations 37 transmit signals 36 along with the ID of the transmitting station. The signals 36 have a predetermined strength level and may be broadcast at predetermined time interval, for example, each 10 times/sec. The signals 36 (and the ID of the transmitting station 37, or AP 20) are received at the monitoring points 24, and RSSI values of the received signals are measured by the hardware 38 (as will be presented infra herein). The MPs 24 are connected through Ethernet network 39 to the security system server 26. The RSSI values measured at the MPs 24, along with the sending MPs ID and time stamp, are supplied to the server 26 for further analysis and detection of a possible intrusion in the area of interest 14.

If an object is present in the area 14 in the region neighboring a respective station 37, the signal transmitted from this respective transmitting station 37 will attenuate while crossing the protected area 14 to the receiving monitoring points 24, and the RSSI value of the signal received at the MPs 24 will deviate from the predetermined strength level (RSSI) of the signal transmitted from the transmitting stations 37. This deviation of the RSSI value of the received signal from the RSSI value of the transmitted signal 36 is indicative of a possible presence of the object(s) in the area of interest.

The server 26 not only uses the RSSI levels of the signals received at the MPs to detect the occurrence of intrusion, but also analysis IDs of transmitting stations, IDs of monitoring points, time stamps, as well as topologies of transmitting stations (APs) and topology of monitoring points to locate the object in the area of interest and to track movement of the object.

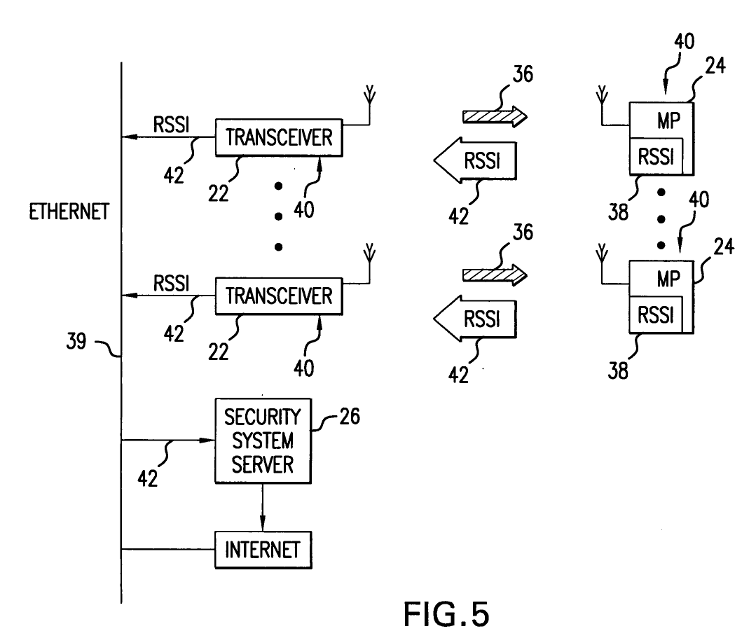

Shown in FIG. 5 is an alternative embodiment of the system 10 of the present invention, which comprises a plurality of transceivers 40 coupled to the security system server 26 over Ethernet 39, and a plurality of monitoring point transceivers 24.

The transceivers 40 of the APs 20 broadcast identical signals 36 of a predetermined strength and at predetermined time intervals. Upon arrival at monitoring points 24, the signals are measured at the measuring hardware 38 to define their RSSI values. The measured RSSI values 42 of the signals received at MPs 24, being represented in the physical layer header, are transmitted back to the AP transceivers 40 to be passed further to the security system server 26 via the Ethernet 39.

The access points 20, as well as monitoring points 24, include transceivers 40, which in different implementations of the system 10 of the present invention, use either transmission or reception, or both capabilities. For example, in the embodiment of the system 10, shown in FIGS. 1, 2, and 5, the signal broadcasting stations (APs 20) also receive signals, while in the system 10, shown in FIGS. 3 and 4, the signal broadcasting stations use mainly the transmitting capability of the transmitting stations 37 to transmit the signals. The transceivers of the monitoring points 24 are used mainly as receivers of the signals, although, in the embodiment shown in FIG. 5, the transceivers 40 of the monitoring points 24 also transmit the RSSI values to the AP transceivers 40.

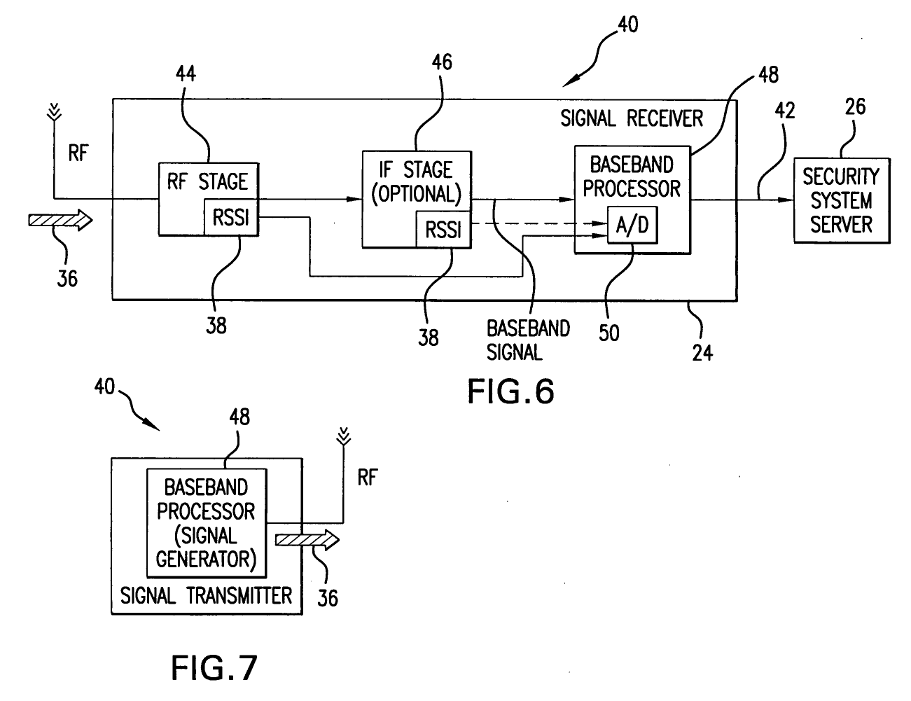

The transceivers used in the system 10 of the present invention are well-known to those skilled in the art, and may be implemented as an interface card, embedded technology, or on-chip circuitry. The transceiver 40, as known to those skilled in the art, includes an RF filter 44, an IF filter 48 (optionally), and a baseband processor 48. As shown in FIG. 6, representing the transceiver 40 in its receiving mode of operation for carrying out the functions of the monitoring point 24, the RF signal 36 is received at the transceiver 40 and the RSSI value is measured during extraction of the baseband signal. The RSSI measurements are carried out at the RF stage (˜2.4 GHz) by the hardware 38, as will be presented infra herein.

Optionally, the RSSI measurement may be performed at the IF stage (˜130 MHz). After passing through the RF stage and optionally through the IF stage, the measurement RSSI values are supplied to the baseband chip (processor) 48 in the form of an analog signal which is passed through an A/D converter 50 to generate a digital value 42 to be reported in the physical layer header to the security system server 26.

As shown in FIG. 7, in the transmitting mode of operation, the baseband processor 48 of the transceiver 40 generates the RF signals 36 of the predetermined strength level, and broadcasts the signals 36 at predetermined time intervals (˜10 signals/sec).

The RSSI value of the signal 36 can be measured during the process of extracting the baseband signal by the hardware 38 at the monitoring points 24. For example, the RF signal received at the monitoring point 24 can be first rectified, and the rectified RF signal then can pass through an integrator to generate a signal which is proportional to the power of the signal 36. Optionally, this process may be repeated in the connected mode for the IF (intra-frequency) stage of the RF receiver of monitoring point 24 at the intermediate frequency (˜130 MHz) to obtain a signal which is proportional to the power of the received signal at the IF stage of the system.

The combination of both signals proportional to the power of the received signal represents the RSSI value of the signal 36 in analog form. This signal is supplied to the baseband chip 48 in the form of an analog signal which is passed through the A/D converter 50 to generate a digital value 42 of the RSSI value of the signal 36, to be reported in the physical layer header. This digital value 42 is obtained not only as the result of RSSI measurements carried out at the monitoring point 24, but also is noted at the wireless card 32 of the user equipment 30 during the scanning mode of operation, if the signal 36 is a beacon.

The physical layer header also contains an indicator of the noise level which is usually determined by measuring the RSSI while the transmitter (the access point) does not transmit.

The baseband chip (processor) 48 encodes and performs conversions of multiple streams of analog and digital content in real time. The baseband chips are known to those skilled in the art and therefore will not be described herein in detail.

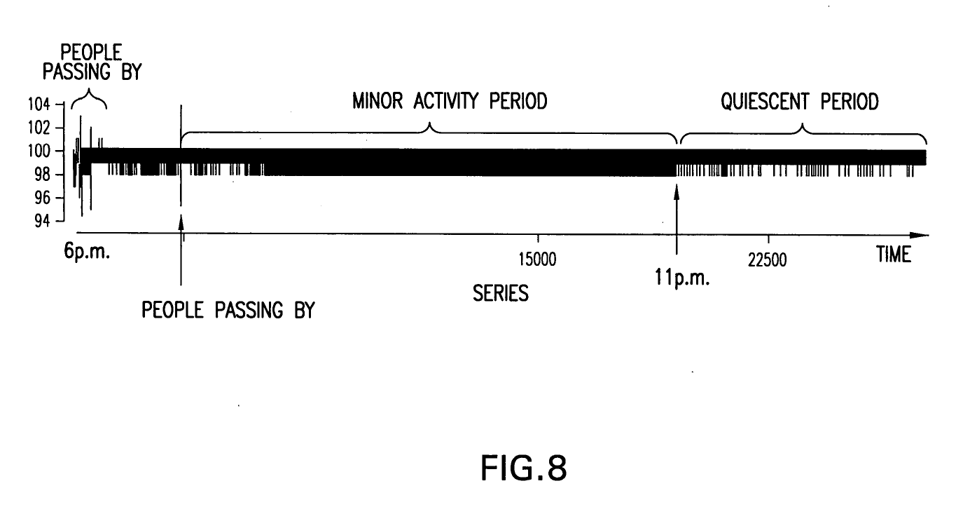

As shown in FIG. 8, the measurements taken during the daytime indicate a significant variability in the RSSI value, both timewise as well as spatially. The spatial variability is usually due to the multi-path effect in a typical building. This was confirmed by conducting an experiment outdoors, showing a systematic variability in the RSSI values. The temporal variability is usually due to the movement of objects in the protected area which affect the 2.4 GHz signal.

In the case when the objects are people, who rarely remain perfectly still during the daytime, their movements result in a change of the RSSI values of the signals 36 broadcast from the access points 20 (transmitting stations 37).

In a quiescent RF environment, where there is no movement or change of any type, if the signal is sent with the same power each time, the RSSI records must also be the same. This was confirmed by making detailed measurements overnight. The variability of the RSSI values nearly disappeared between 11 PM and 6 AM, as shown in FIG. 8, when there were no people in the protected area 14. Further controlled experiments conducted during the nighttime (between 11 PM and 6 AM) confirmed that if a person comes into the protected area during this time, the security system 10 detects the presence of this person in the protected area by monitoring the RSSI values of signals 36 broadcast by the transmitting stations 37 (APs 20, transmitters 34).

The security system 10 supports three modes of operation, which include a monitoring mode, a tracking mode, and a security mode.

In the monitoring mode, the security system expects no movement of objects anywhere in the protected area and issues alarms upon detection of any movement. This mode of operation may be appropriate for providing security during the night time. In the monitoring mode of operation, the monitoring points 24 not only measure the RSSI values and transmit the measured RSSI values to the server 26 but the MPs 24 also can recognize the change of RSSI values and inform the security system server 26 accordingly. The server 26 then takes the appropriate security steps reflecting the specific predetermined configurations.

In the tracking mode of operation, the security system 10 not only detects the presence of an intruder, it also provides the location and the path taken by the intruder in the protected area. In the tracking mode, the security system tracks one intruder at a time. This mode of operation is suitable for supporting protection at night.

In the tracking mode of operation, each monitoring point 24 measures the RSSI value, and sends them to the security system server 26 along with the MPS' IDs. The security system server 26 uses this information to determine the location of the intruder. Over time, the pattern of the intruder's movement is computed, analyzed, and used for taking the appropriate security actions by the server 26.

In the security mode of operation, the system 10 tracks multiple people and keeps track of each separately. This mode of operation is suitable for daytime monitoring and tracking the movement of each person in the protected area.

In the security system 10 of the present invention, any device capable of receiving signals and measuring the RSSI value thereof is capable of operating as a monitoring point. For example, access points may operate as monitoring points for other access points. In addition, the user equipment 30, such as, for example, client computers in the protected area, can run the software necessary to carry out the monitoring point's function. The security system server 26 is a dedicated computer, however, the workload of the server 26 is small enough to provide its functionality by executing the server software on any other server in the system.

The security system technology of the present invention, which is intended to be called “Nuzzer” technology, is a powerful tool which provides the added capability of physical intrusion detection and tracking without requiring any special hardware. It is an efficient, cost-effective, software-based solution that adds to the value of any Wi-Fi installation. One of the most effective capabilities of the security system 10 of the present invention is that there is no need for people to carry any hardware in order to be detected by this system. This quality makes the security system 10 an ideal technology for intrusion detection in areas where Wi-Fi systems are already installed. Moreover, tracking is done efficiently by the security system using components of the installed Wi-Fi system, making this approach extremely cost effective. This software based approach is easy to install and easy to use.

Although this invention has been described in connection with specific forms and embodiments thereof, it will be appreciated that various modifications other than those discussed above may be resorted to without departing from the spirit or scope of the invention as defined in the appended claims. For example, equivalent elements may be substituted for those specifically shown and described, certain features may be used independently of other features, and in certain cases, particular locations of elements may be reversed or interposed, all without departing from the spirit or scope of the invention as defined in the appended claims.

1. A security system for detecting presence of an object in an area of interest, comprising:
a plurality of transmitting stations deployed in the area of interest, each transmitting station broadcasting signals of a predetermined strength level;
a plurality of monitoring points, said monitoring points receiving signals broadcast by said transmitting stations,
means for measuring Received Signal Strength Indicator (RSSI) values of said signals received at said monitoring points;
a security system server communicating with said plurality of the monitoring points, said security system server receiving said measured RSSI values; and
means associated with said security system server for analyzing said RSSI values to detect presence of the object in the area of interest.

2. The security system of claim 1, further comprising means for issuing a predetermined indicia once at least one measured RSSI value of the signals received at said monitoring points deviates from said predetermined strength level.

3. The security system of claim 1, further comprising a wireless fidelity (Wi-Fi) infrastructure in the area of interest, wherein said transmitting stations include access points of said Wi-Fi infrastructure.

4. The security system of claim 1, wherein said measuring means are associated with each of said monitoring points.

5. The security system of claim 2,
wherein the deviation of said at least one RSSI value of the signals received at said monitoring points from said predetermined strength level of said signals broadcast from said transmitting stations is indicative of a presence of at least one object in said area of interest.

6. The security system of claim 5, further comprising means associated with said security system server for tracking the movement of said at least one object.

7. The security system of claim 2, further comprising means associated with said security system server for initiating security actions once said deviation of the measured RSSI value from said predetermined strength level has been detected.

8. The security system of claim 5, further comprising means for generating a notification of the detected movement of the at least one object in said area of interest.

9. The security system of claim 8, further comprising connection to Internet, and means for sending said notification to a predetermined entity through the Internet.

10. The security system of claim 1, further comprising means associated with said security system server for storing a topology of said transmitting stations deployed in said area of interest.

11. The security system of claim 1, further comprising means associated with said security system server for storing a topology of said monitoring points in said area of interest.

12. The security system of claim 1, further comprising means for transmitting identification data of said monitoring points along with said measured RSSI values to said security system server.

13. The security system of claim 6, wherein said tracking means is for keeping track of the movement of said at least one object in real time.

14. The system of claim 6, wherein said tracking means is for reporting the movement of said at least one object.

15. The security system of claim 1, further comprising means associated with said monitoring points for keeping track of said measured RSSI values of the signals received at said monitoring points.

16. The security systems of claim 15, further comprising means for notifying said security system server when a deviation of said measured RSSI value from said predetermined strength level has been recognized.

17. The security system of claim 3, wherein said access points form an access points network, said access points network interconnecting a wireless network and a wired network.

18. The security system of claim 1, further comprising means associated with each of said transmitting stations for transmitting an ID thereof to said monitoring points along with said signals.

19. The security system of claim 12, further comprising means for transmitting a time indicia of communications from said monitoring points to said security system server.

20. The security system of claim 1, wherein said transmitting stations include generators of said signals of said predetermined strength level at predetermined time intervals.

21. The security system of claim 1, wherein said monitoring points are connected to said security system server via Ethernet.

22. The security system of claim 1, wherein said transmitting stations include transceivers, said transceivers being connected to said security system server, said measured RSSI values being transmitted to said security system server via said transmitting stations.

23. A method for detecting presence of an object in an area of interest, comprising the steps of:
deploying a plurality of transmitting stations in the area of interest;
deploying a plurality of monitoring points (MPs) in the area of interest;
broadcasting signals of a predetermined strength level from said transmitting stations;
receiving said signals at said monitoring points;
measuring a Received Signal Strength Indicator (RSSI) value of each of said signals received at said monitoring points; and
analyzing said measured RSSI values to detect presence of an object in the area of interest.

24. The method of claim 23, further comprising the steps of
issuing a warning indicia when at least one said RSSI value deviates from said predetermined strength level.

25. The method of claim 23, further comprising the steps of:
coupling a security system server to said plurality of the monitoring points;
transmitting said RSSI values from said monitoring points along with identification thereof to said security system server; and
analyzing said RSSI values in said security system server.

26. The system of claim 25, further comprising the step of:
recording a topology of said transmitting stations in said security system server.

27. The method of claim 25, further comprising the step of:
recording a topology of said plurality of monitoring points in said security server.

28. The method of claim 24, wherein said deviation of the at least one RSSI value from said predetermined strength level is indicative of presence of an object in said area of interest.

29. The method of claim 28, further comprising the steps of:
actuating a monitoring mode of operation to detect presence of the object when no presence of the object in said area of interest is expected.

30. The method of claim 29, further comprising the steps of:
in said monitoring mode of operation,
recognizing at said each monitoring point, the deviation of said at least one RSSI value from said predetermined strength level; and
transmitting a notification signal indicative of said deviation detection from said monitoring points to said security system server.

31. The method of claim 28, further comprising the steps of:
actuating a tracking mode of operation to detect presence of an object in said area of interest, the location of the object, and a path taken by the object in said area of interest;
in said tracking mode of operation at said security system server,
computing the location of the object based on the RSSI values, the topology of said monitoring points, and the topology of said transmitting stations.

32. The method of claim 31, further comprising the step of:
computing at said security system server, a pattern of the object's movement in said area of interest.

33. The method of claim 28, further comprising the step of:
actuating a security mode of operation to track multiple objects in said area of interest and to keep track of the movement of each object in said area of interest.

34. The method of claim 28, further comprising the step of initiating security actions.

35. The method of claim 23, further comprising the step of:
deploying a Wi-Fi infrastructure in the area of interest, said Wi-Fi infrastructure including a plurality of access points, said access points having said transmitting stations.

36. The method of claim 25, further comprising the steps of:
transmitting an identification of said each monitoring point to said security server, along with a time of the RSSI value transmission.

37. The method of claim 23, further comprising the step of:
at said monitoring points, keeping track of the measured RSSI values received from said transmitting stations.

38. The method of claim 24, further comprising the steps of:
generating notification messages once said deviation has been detected; and
sending the notification messages through Internet to predetermined addresses.
